(19) United States
(12) Patent Application Publication
(10) Pub. No.: US 2005/0046191 A1
(43) Pub. Date: Mar. 3, 2005

(54) Lightweight portable electric generator

(75) Inventors: Gregory Cole, Melbourne, FL (US); Brian Tews, Melbourne, FL (US); Robert Scaringe, Rockledge, FL (US); Russell Davis, Melbourne, FL (US)

Correspondence Address: CROWELL & MORING LLP;INTELLECTUAL PROPERTY GROUP, P.O. BOX 14300, WASHINGTON, DC, 20044-4300, US

(73) Assignee: Mainstream Engineering Corporation.

(21) Appl. No.: 10/649,793

(22) Filed: Aug. 28, 2003

(51) Int. Cl. H02K 9/04

(52) U.S. Cl. 290/1 A; 123/41.31

(57) ABSTRACT

A compact and lightweight electric generator for portable power applications employs a new engine design and integration approach for reducing engine and generator weight. A unique flywheel alternator generates electrical power and provides inertia for the engine, pressurized air for cooling, and inertia for the alternator. An engine cowling provides rotating component protection, a fan shroud mechanism, cooling air ducts, and a cooling mechanism for handling large quantities of heat produced by rectified power conversion.

### BACKGROUND OF THE INVENTION

1. Field of the Invention

The present invention relates to electrical generators, particularly, to size and weight improvements of air-cooled, portable electric generators. A flywheel alternator mounted on an air-cooled internal combustion engine generates electrical power. Improvements in the engine design and the functionality of the integrated flywheel alternator result in a smaller and lighter generator that is easier to transport.

2. Description of the Related Art

Air-cooled, portable electric generators of the prior art are typically comprised of an air-cooled internal combustion engine coupled mechanically through a power takeoff shaft to an alternator. The power takeoff shaft is typically integral to the crankshaft on the side of the engine opposed to the engine flywheel, although power takeoff shafts integral to the camshaft on a side of the engine opposed to the engine flywheel are also common. The flywheel provides an inertial means of reducing shaft speed fluctuations that are created by the cyclic torque of reciprocating machines. In this configuration the alternator has its own set of bearings for supporting the alternator rotor, which is coupled to the power takeoff shaft through a flexible or rigid coupling. The alternator assembly is mounted on a frame common with the engine. This configuration is often selected when the engine manufacturer is different from the alternator manufacturer. It is the easiest configuration to assemble from commercially available engine and alternator components. However, it is typically bulky and heavy due to lack of weight optimization and integration. Examples of such prior art generators include 2-kW Military Tactical Generator Sets (MTGs) by Dewey Electronics Corporation and Mechron Power Systems, Inc. The 2-kW, 120-VAC, 60-Hz Dewey MTG (model no. MEP 531A) has a dry weight of 143.1 lbs. and is comprised of a commercial alternator mounted to a Yanmar L48AE-DEG engine. The 2-kW, 28-VDC Dewey MTG (model no. MEP501A) has a dry weight of 123.5 lbs. and is comprised of a Balmar alternator mounted to a Yanmar L48AE-DEG engine. The AC and DC versions of the Mechron 2-kW MTGs are also comprised of a commercial alternator mounted to a Yanmar L48AE-DEG engine and have dry weights of 141 lbs. and 126 lbs., respectively. In another common configuration, the alternator rotor is mounted directly on the power takeoff shaft and the alternator stator is fixed to the engine housing or engine block. The independent alternator shaft, bearings, bearing housing, and coupling of the first configuration are eliminated. The second configuration is also typically employed when the engine manufacturer is different from the alternator manufacturer. However, this type of generator is typically assembled from a commercially available engine and an alternator designed specifically for the engine power takeoff shaft. This configuration provides a size and weight improvement over the first configuration, however, full optimization and complete integration is still lacking. An example of such prior art generators include Polar Power Inc. alternator model 3500 or 6250 mounted to commercial Yanmar L40, Yanmar L48, Yanmar L70, or Lister Potter LPA2 engines. The dry weight of a Polar 35000 alternator mounted on a Yanmar L48AE-DE engine is 91 lbs. (not including instrumentation and generator frame).

Additional size and weight reductions can be achieved when the engine manufacturer is the same as the alternator manufacturer, or the manufacturer of the engine and the manufacturer of the alternator work in unison during the design phase to produce a system wherein not only is each component optimized for size and weight, but the overall system is optimized as well. The two largest components of an electric generator are typically the engine block and the alternator. Therefore, the present invention is aimed at reducing the size and weight of the engine block and alternator.

Throughout the 20^{th} century, a majority of engine blocks were manufactured from cast iron. Lightweight alloys, primarily aluminum, replace cast iron in mobile applications (automotive engines, marine engines, generator set engines, etc.). In the 1990s, with the impetus to reduce engine emissions, major automotive engine manufacturers turned to even lighter weight alloys such as magnesium to reduce engine weight, thereby reducing automobile weight, reducing power requirements, and reducing emissions. Magnesium alloys are approximately 33% less dense than aluminum and 75% less dense than cast iron. Therefore, when designing a new engine for mobile electric power generation, from a weight optimization perspective, magnesium alloys are considered the most desirable, aluminum alloys the second most desirable, and cast iron the least desirable. Of the magnesium alloys, magnesium-aluminum (AM) and magnesium-aluminum-zinc (AZ) alloys have excellent room temperature strength and/or ductility but do not exhibit good creep resistance. AZ alloys have good corrosion resistance properties as well. Magnesium-aluminum-rare earth (AE) and magnesium-aluminum-silicon (AS) have been developed to improve elevated-temperature performance. AS alloys only provide a marginal improvement in creep resistance. AE alloys are expensive due to rare-earth additions, have poor die cast properties, have high oxidation rate, and low fatigue resistance. Industry has devoted significant investments of time and money to develop new high temperature magnesium alloys. An alternative solution is to design the engine with reduced stress, temperature, and creep requirements that do not exceed the material properties of currently available materials.

As previously discussed, the second potential area for significantly reducing the weight of a portable generator is the alternator. The greatest potential for weight savings is to design the alternator as an integral component of the engine. That is, design the generator as an integrated unit, not the coupling of individual units. Fully integrated systems where the alternator is integral to the engine flywheel are common in the marine industry. However, the electric power generated by the alternator is small compared to the mechanical power generated by the shaft. The mechanical power is typically used to drive a mechanical mechanism such as a propeller and the electrical power is typically used for auxiliary lighting and control equipment. Those alternators are not designed to utilize all of the mechanical power generated by the engine shaft. In generators, where all of the mechanical power is converted to electrical power there is a larger portion of waste heat that is developed due to the conversion. The waste heat that is produced due to the inefficiency of the power conversion devices must be removed for proper operation of the generator. Further, marine engines with flywheel alternators are typically water-cooled.

In portable electric generators, a fan sufficient for removing large quantities of waste heat produced by power electronics must be incorporated. Finned structures common on existing flywheels alternators are not able to provide ample cooling to both the engine and the alternator. Most often the fins merely ventilate low power electronics used to create a spark for spark ignition type engines or low power electronics used to run auxiliary systems. Larger power generation creates larger quantities of waste heat that can not be removed by simple paddle style circulators.

### SUMMARY OF THE INVENTION

The present invention relates to air-cooled, portable electric power generation equipment where mechanical power is not required. The internal combustion engine and the alternator are designed as an integrated unit and the alternator is the only driven mechanism of the engine. The internal combustion engine in the currently preferred embodiment is of the compression ignition type, although it will be apparent to anyone skilled in the art that the present invention also applies to spark ignition type engines.

Therefore, in light of the benefits of an integrated, lightweight, portable generator, as well as, the aforementioned shortcomings in the prior art, this invention has among other things, the following objectives:

To provide an improved air-cooled, internal combustion engine that is capable of utilizing existing lightweight alloys. Existing light alloy materials often have creep resistance at elevated temperatures that is less than the creep resistance of heavier materials.

To integrate the generator alternator into the engine flywheel to eliminate excessive components and reduce weight. The new flywheel alternator provides inertia to reduce speed fluctuations, provides a means of cooling both the electrical and mechanical components, and generates electrical power.

To provide an improved multi-function engine cowling, that not only provides protection from and to the rotating components, but also serves as a fan shroud, a fan scroll (or volute), a coolant distributor (to cool the engine, alternator, and engine oil), an electronic cold plate (for mounting and cooling rectification and/or voltage regulation electronics), and a coolant duct.

### BRIEF DESCRIPTION OF THE DRAWINGS

Other objects, advantages and novel features of the present invention will become apparent from the following detailed description when considered in conjunction with the accompanying drawings herein.

FIG. 1 is an end elevational view of the currently preferred embodiment of the electrical generator in accordance with the present invention.

FIG. 2 is a partially exploded side elevational view of the electrical generator of FIG. 1.

FIG. 3 is a back perspective view of the flywheel alternator with an integral centrifugal-type cooling fan.

FIG. 4 is a front perspective view of the flywheel alternator with an integral centrifugal-type cooling fan as shown in FIG. 3.

FIG. 5 is a front perspective view of the flywheel alternator with an integral axial-type cooling fan.

FIG. 6 is a cross-sectional view of a constant angle blade for axial-type fans.

FIG. 7 is a cross-sectional view of an airfoil blade for axial-type fans.

FIG. 8 is a wiring diagram for the stator and rectifier electronics.

FIG. 9 is an elevational view of the electrical generator mounted in a backpack assembly.

FIG. 10 is an elevational view of the electrical generator mounted in a rollcage assembly.

### DETAILED DESCRIPTION OF THE INVENTION

The present invention relates to air-cooled, portable electric power generation equipment. The internal combustion engine and the alternator are designed as an integrated unit and the alternator is the only driven mechanism of the engine. The internal combustion engine in the currently preferred embodiment is of the compression ignition type, although it will be apparent to anyone skilled in the art that the present invention also applies to spark ignition type engines. The following terms are defined to assist with the description of the invention as used the context of the present invention.

An internal combustion engine (or engine) is a device that generates mechanical power through the combustion of fuel. Compression-ignition engines and spark-ignition engines are types of engines.

An alternator is a device that converts mechanical power into alternating electrical power through the use of electromagnetic fields. Permanent magnet alternators are a type of alternator wherein the magnetic field is generated by permanent magnets.

A flywheel is a device that provides inertia to a rotating machine. In the context of this invention, the inertia is provided to reduce speed fluctuations and vibration of the engine.

A flywheel alternator is a type of alternator wherein the function of the alternator and the function of the flywheel are combined in a single component or single subassembly.

An electric generator (or generator) is a generic term for a device that creates electrical power. In the context of the present invention a generator is machine comprised of an engine and an alternator.

An engine cowling is a generic term given to an engine cover. In the context of the present invention, the engine cowling is comprised of one or more components and provides multiple functions.

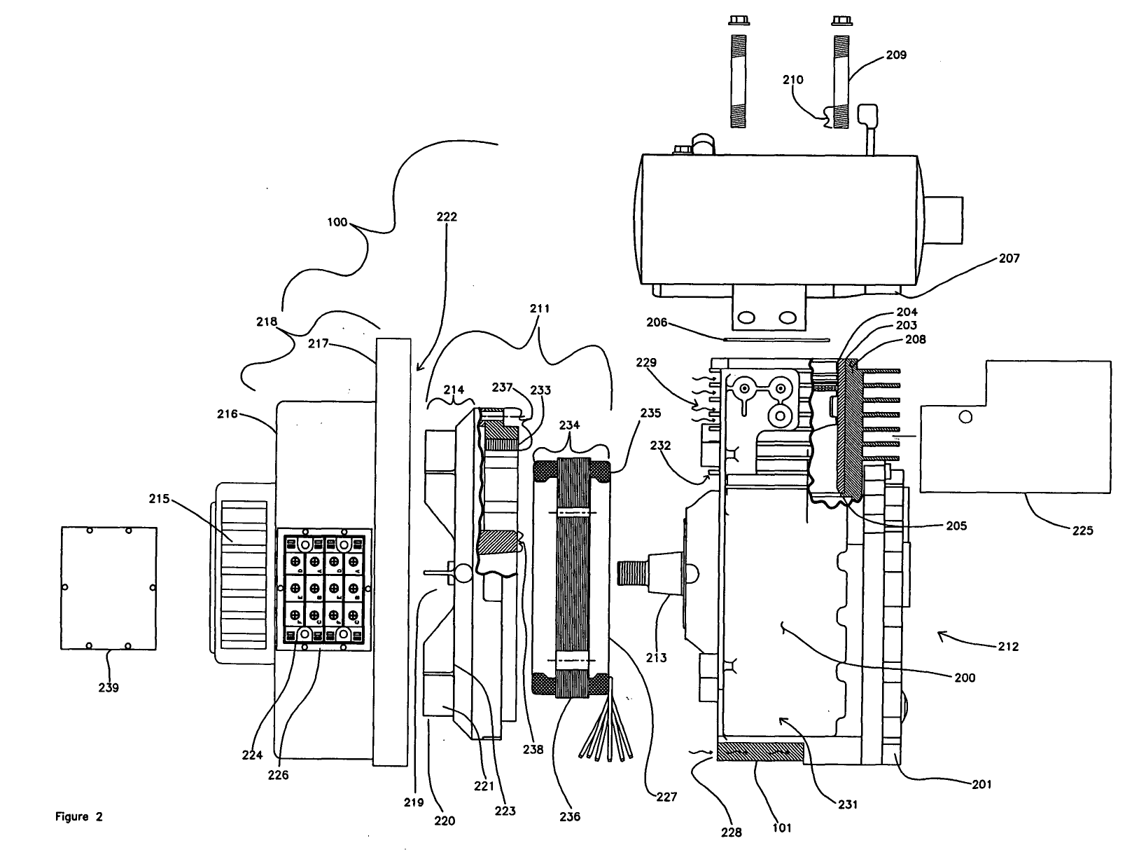

Referring to FIG. 2, the engine block 200 and engine block cover 201 are fabricated with a light alloy. For mobile applications where a lightweight generator is desired, the preferable light alloy is magnesium. Magnesium alloys have a density approximately two-thirds that of aluminum alloys and only a slight reduction in room temperature strength. However, the present invention is not limited to magnesium and other alloys such as aluminum are also possible. The light alloy engine block may be cast, machined from wrought metal, forged, or formed using conventional methods.

A portion of the engine block contains one or more cylinder walls 203. A cylinder liner 204, preferably made of a high temperature metal such as cast iron, is either cast in place, press fitted, or shrunk fitted into each cylinder bore. An interference fit is created between the cylinder wall 203 and cylinder liner 204 that must be large enough to maintain an interference fit during high temperature operating conditions. It is common that the cylinder wall 203 will expand at a greater rate than the cylinder liner 204 due to higher coefficient of linear thermal expansion. A shoulder 205 or other retaining means is included at the base of the cylinder wall 203 to prevent downward movement of the cylinder liner 204 in the event of a loss of interference fit.

The cylinder gasket 206 and engine head 207, which are removable during disassembly, restrict upward motion of the cylinder liner 204. Because the cylinder head 207 forms one wall of the combustion chamber, the head must be formed from a high temperature metal or a metal coated with a high temperature material. In the currently preferred embodiment, aluminum is used as the head material. The head is attached to the cylinder housing 208 using threaded fasteners such as head bolts or head studs 209. These fasteners are highly stressed during the compression stroke in compression ignition engines due to the high gas pressure required for self-ignition. The axial stress of the fastener is transmitted to the cylinder housing 208 through the threaded portion of the fastener 210, thus creating high stresses in the cylinder housing 208. When magnesium alloys are used for the engine block 200, elevated temperatures reduce both creep resistance and threaded fastener load retention of the cylinder housing 208. For highly stressed threaded fasteners where pullout due to thread stripping or fastener bucket may introduce life and reliability concerns, threaded inserts may be employed. An increase in thread tensile area provided by the insert prevents thread stripping. The high temperature strength of the intermediate threaded insert material prevents fastener backout due to creep.

In the disclosed invention, the integrated generator 100 contains a flywheel alternator 211 that performs multiple functions. Specifically, the flywheel alternator provides inertia for the engine 212, forced air cooling for the internal-combustion engine 212, alternator 234, and electronics, electrical power generation, and a speed and voltage regulating device for the electrical power generator. The air cooled electronics are typically mounted to a cold plate or heat sink and housed in an electronics box 226.

Cyclical combustion of reciprocating-type internal combustion engines creates torque pulsations that would result in crankshaft 213 speed fluctuations if the crankshaft 213 were not restrained. The rotor of the flywheel alternator provides an inertial means of reducing the speed fluctuations and engine vibration. Constant speed is also beneficial to permanent magnet alternators to regulate voltage, current, and frequency.

Flywheel size is a function of the required mass-moment of inertia. Torque variation in the crankshaft, generated by the cyclical combustion process, is calculated throughout one complete cycle. The mean torque value for the complete cycle is used to calculate instantaneous kinetic energy and energy variation throughout the cycle. Net kinetic energy, energy variation difference, and allowable speed range (or coefficient of speed fluctuation, defined as the allowable speed range divided by the mean speed) are then used to determine the required mass-moment of inertia. The smaller the allowable speed range (or the smaller the coefficient of speed fluctuation) the larger the required mass-moment of inertia or vise versa. By way of example, a net kinetic energy of 163.78 J (120.80 ft-lbf), an energy variation difference of 239.53 J (176.67 ft-lbf), an allowable speed range of plus or minus 360 rpm, and a nominal rotational speed of 3600 rpm (a coefficient of speed fluctuation of 0.2) results in a required mass-moment of inertia of 0.00843 kg-m2 (0.200 lbm-ft2). This coefficient of speed fluctuation is typical for machines where large speed variation is acceptable. In the currently preferred embodiment, the mass-moment of inertia is larger due to alternator requirements and therefore the speed fluctuations are smaller. A mass-moment of inertia of 0.0169 kg-m2 (0.401 lbm-ft2) results in an allowable speed range of plus or minus 120 rpm (a coefficient of speed fluctuation of 0.067). This coefficient of speed fluctuation is typical in cases where moderate speed variation is acceptable. The present invention is not limited to this speed variation or mass-moment of inertia as other values are acceptable. No additional inertia mechanism beyond the rotor of the flywheel alternator is required for the generator 100.

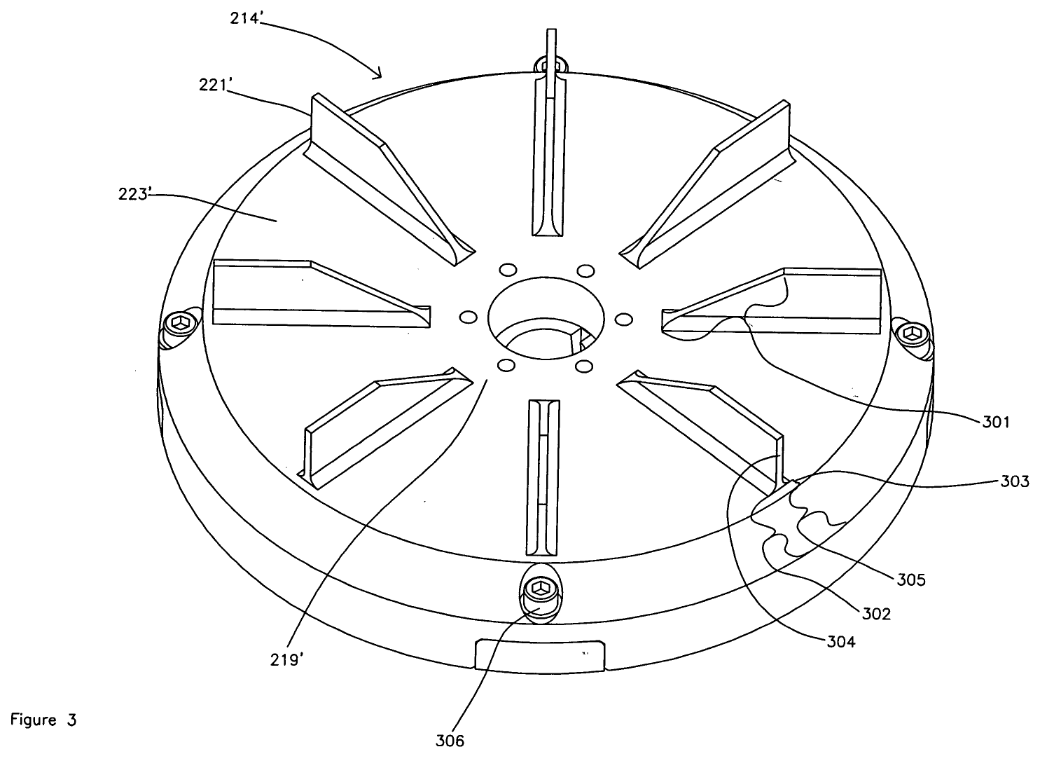

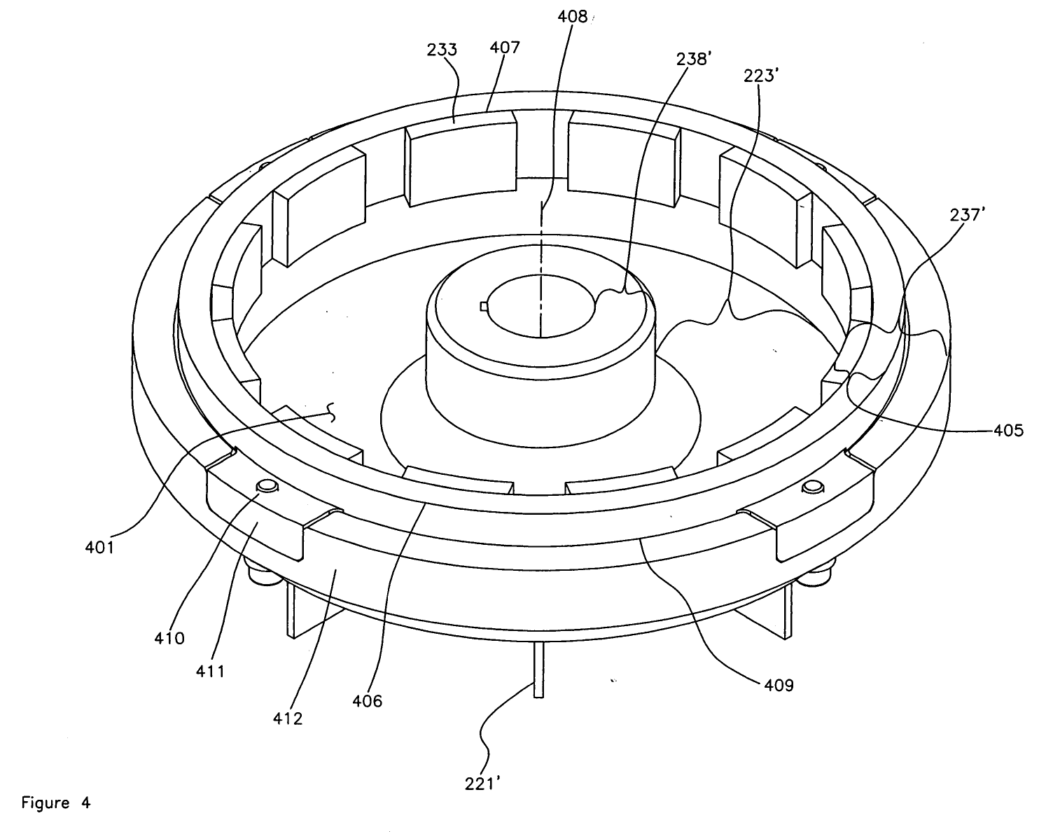

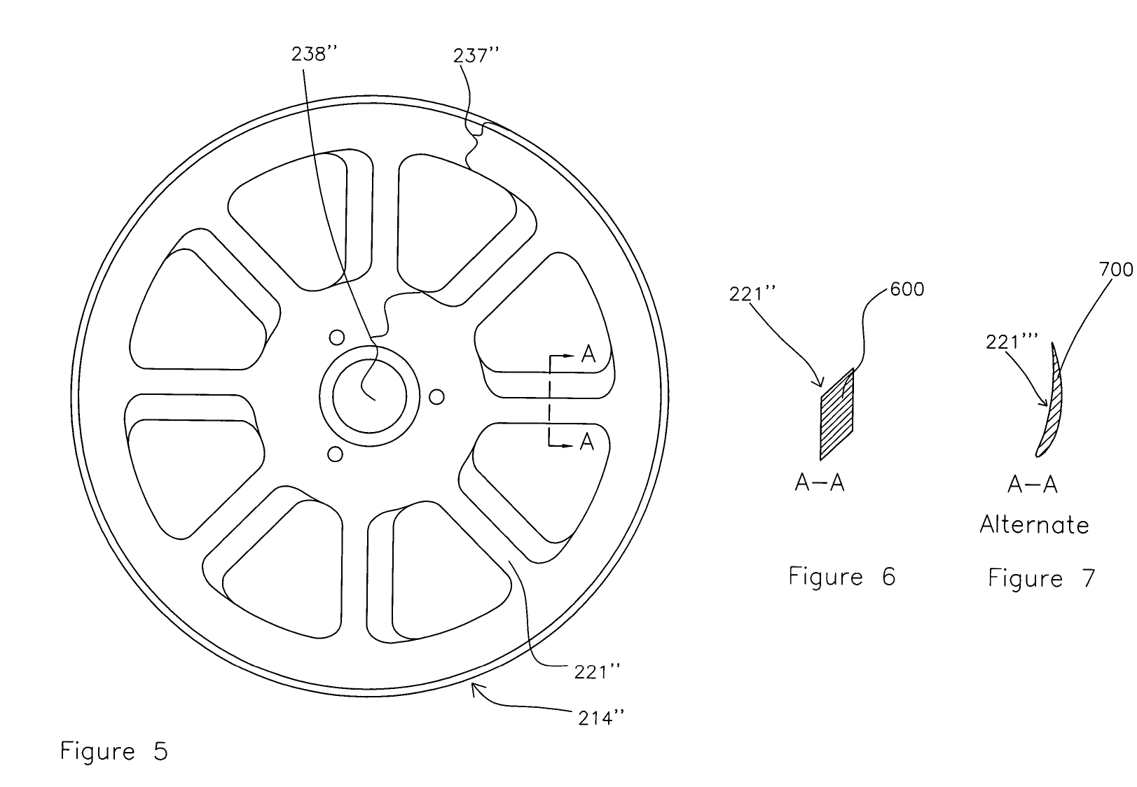

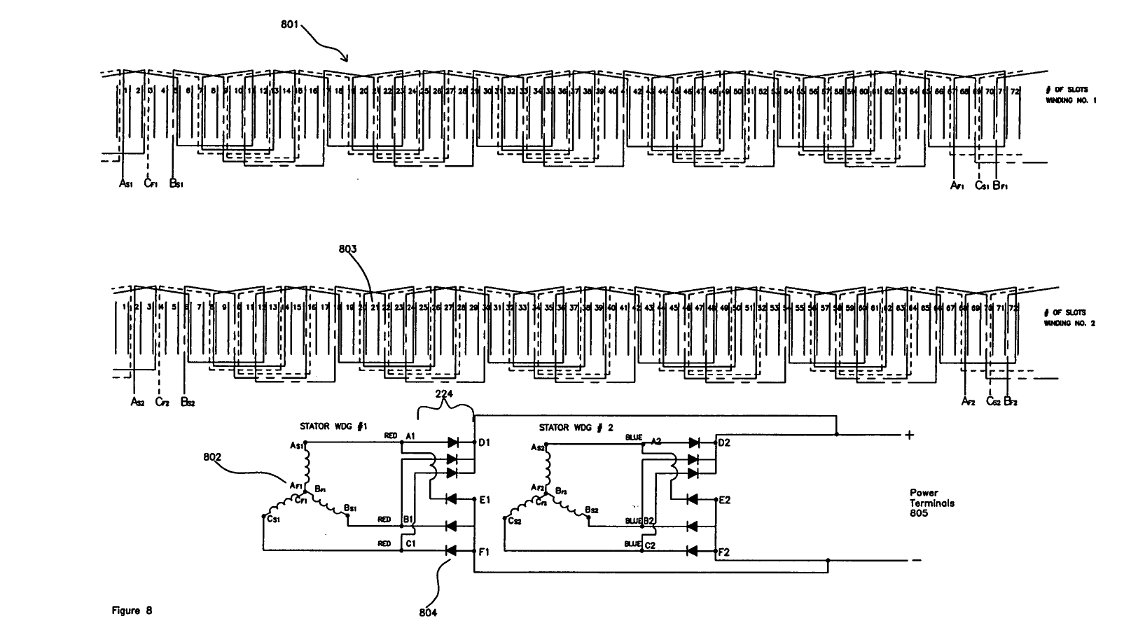

The flywheel alternator also contains a fan 214 for cooling the generator. The fan can be of the centrifugal-, axial-, of mixed flow-type. Referring to FIGS. 3 and 4, in the centrifugal-type fan 214′, the fan blades 221′ provide the singular function of providing forced air cooling for the generator. The fan hub 223′ provides the mechanical connection of the inertia portion 237′ of the flywheel to the mounting portion 238′ of the flywheel and acts as a single solid spoke. If the fan blade/fan hub assembly or impeller is shrouded, the impeller shroud may also act as a way of attaching the inertia portion of the flywheel to the mounting portion of the flywheel. The impeller shroud can be used to either decrease the stress in the spoked hub or decrease the cross-sectional area of the spoked hub 223′. Openings (not shown) may be formed into the fan hub 223′ to increase airflow to the backside of the hub 401 for cooling generator components. The additional openings increase the number of spokes on the fan hub 223′. In the axial-type fan 214″ shown in FIGS. 5-7, the fan blades 221″ perform two functions. The first function is to impart momentum to the flow, thereby forcing air through the engine cowling to cool the generator. The cross-sectional area 600 of the fan blades 221″ can be of the simple constant angle type (FIG. 6) for ease of manufacturing or for the fan blades 221′″ of the airfoil type 700 (FIG. 7) for optimum efficiency. The second function is to provide a mechanical linking of the inertia portion of the flywheel 237″ to the mounting portion of the flywheel 238″. In this sense the fan blades 221″ also act as flywheel spokes. Mixed flow-type fans can also be employed. Again, the fan not only generates the flow necessary for cooling the generator, but also mechanically fastens the inertia portion of the flywheel to the mounting portion of the flywheel. It should be clear to anyone skilled in the art that the entire fan acts to provide inertia. Reference is made to the inertia portion 237 of the fan only to indicate that due to the relatively large amount of mass at the largest diameter that this section of the flywheel typically provides more inertia than the fan blades 221, fan hub 223, fan shroud (if employed), and mounting portion 238 of the flywheel.

Both the internal combustion engine 212 and electric power generation components are cooled. The fan 214 draws air through inlet opening 215 of the fan shroud 216. The fan shroud 216 and the shroud mounting portion 217 are integral to the engine cowling 218. The fan 214 moves the air from the low-pressure side 219 of the flywheel alternator to the exit of the flywheel alternator 220, increasing the air pressure in the process. In the currently preferred embodiment, a centrifugal fan 214′ is used. Air enters the fan inlet 219′ primarily in an axial direction. The fan impeller blades 221′ impart momentum to the air, moving the air centrifugally outward and increasing the stagnation pressure of the air. The fan impeller blades 221′ may be curved for optimum efficiency or radial for ease of manufacturing. In the currently preferred embodiment, eight fan blades 221′, each with a total blade length equal to 2.525 inches and a blade thickness equal to 0.100 inches are employed. The blade inlet 301 begins at a radial distance 1.350 inches from the fan axis and tapers to a height of 0.830 inches at a radial distance 2.750 inches from the fan axis. A diffuser 302 either of the vaned or vaneless type is located concentrically with respect to the fan impeller. The diffuser 302 converts some of the air stagnation pressure to static pressure prior to entering the fan scroll 222 or volute. As the air is collected in the scroll 222, more of the stagnation pressure is converted to static pressure. The scroll 222 is also integral to the engine cowling 218. In the currently preferred embodiment, a straight vaneless diffuser region 303 extends 0.438 inches radially from the end of the blades 304. A tapered vaneless diffuser region 305 extends another 0.250 inches radially beyond the end of the straight vaneless section and 0.250 inches axially from the fan hub surface 223′. The scroll 222 spirals outward, beginning at 0.250 inches radially from the diffuser 302 and ending at 1.500 inches radially from the same diffuser 305.

The engine cowling 218 performs several functions. An integral fan shroud 216 is provided that protects the rotating fan 214 from foreign objects and also protects users from the rotating fan 214. The engine cowling 218 also protects the flywheel alternator 211. In the case of a centrifugal-type fan, the fan shroud 216 completes the high velocity fan passages formed by the fan blades 221 and fan hub 223. It should be noted that the fan shroud 216 is not required to be integral to the engine cowling 218. The fan shroud 216 can also be integral to the fan impeller as described previously. The engine cowling 218 also contains the scroll 222 for centrifugal-type fans. A portion of the scroll 222 or engine cowling 218 may be used to cool high power devices mounted to a coldplate that is an integral part of the engine cowling. The engine cowling 218 also directs the flow of air to the engine 212. The removable ductwork 225 provides an air cooling passage that controls the flow of air to critical engine locations, including the cylinder wall, the engine head, the engine block, and the oil sump.

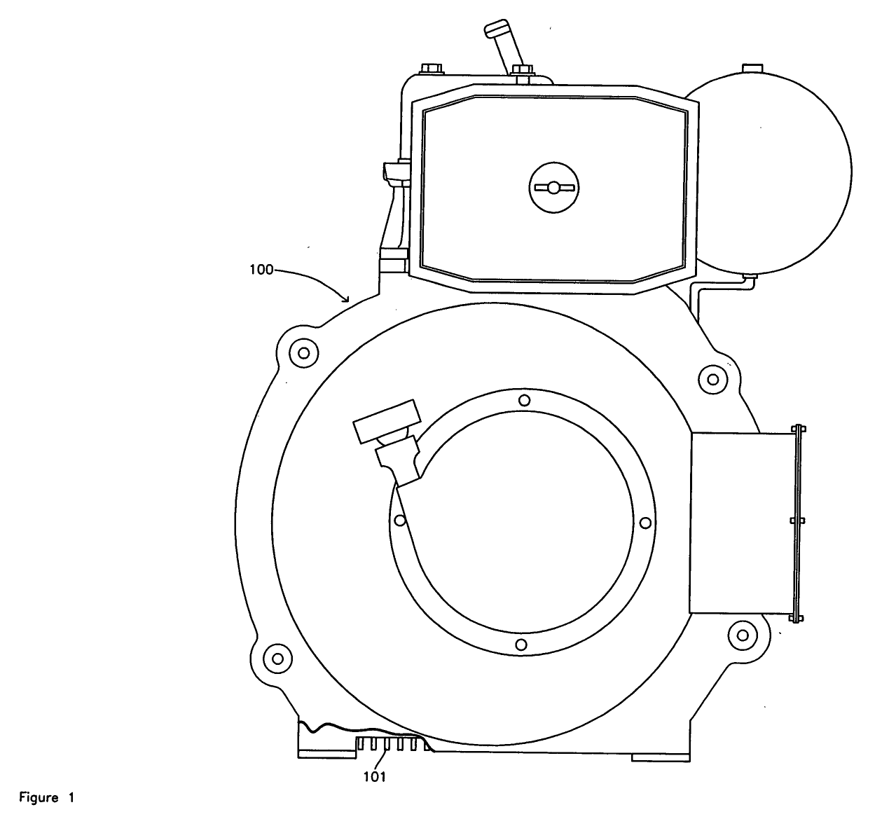

Cooling air is first directed to the generator electrical components, which are typically required to be maintained at a lower temperature than the engine 212. The air cools the electronics coldplate 226 and then the alternator stator 227. Electronic devices, such as rectifiers 224, diodes, or other electronics can be mounted to the coldplate. After cooling the critical electrical components, the air splits into multiple flow paths. One flow is at the base of the engine 228 and the other flow 229 is around the cylinder housing 208 and the engine head 207. The flow passage at the base of the engine 228 contains fins 101 (FIG. 1). As these fins 101 are integral to the engine block 200, their geometric dimensions are optimized based on the material selected for the engine block material. The purpose of cooling the engine block 200 at this location is to remove heat from the oil. The oil sump or oil reservoir 231 for the engine block 200 is located at the side of the engine block opposed to cooling fins 101 at the base. The oil temperature must be maintained at a level, typically less than 240° F., the temperature at which most additives in the lubrication oil break down. The passage 229 at the cylinder housing 208 and head 207 of the engine 212 also contains cooling fins 232. These fins 232 are also integral to the engine block 200 and geometrically dimensioned so as to optimize the removal of heat from the cylinder housing 208 and head 207. The optimization is a function of the engine block material.

In the currently preferred embodiment, cooling fins 232 are fabricated integral to the engine block 200 and cast with a magnesium alloy. Eight fins 232 spaced 0.315 inches apart with a fin thickness of 0.080 inches, heights of 0.280 inches and lengths ranging from 3.25 to 4.86 inches were determined to provide the optimal heat removal from the cylinder housing 208 and head 207. This configuration provides approximately 1400 Watts (4780 Btu/hr) of cooling when the temperature difference between the average fin temperature and the ambient temperature is 170° F. Fifteen fins 101 spaced 0.300 inches apart with a fin thickness of 0.100 inches and a fin height of 0.275 inches remove an additional heat from the oil sump 231. Approximately 150 Watts (512 Btu/hr) of heat is removed when the temperature difference between the average fin temperature and the ambient temperature is 170° F.

The flywheel alternator 211 also produces the electrical power for the generator 100. The preferred alternator type is a permanent magnet alternator. Permanent magnet alternators are the simplest, most efficient, and most reliable type of alternator. There are no brushes, slip rings, or rotating fields, thereby eliminating wear components and reducing electromagnetic interference emission. Permanent magnet alternators are typically classified as either axial gap or radial gap, referring the orientation of the airgap between the rotor and stator relative to the axis of rotation. Axial gap (also known as pancake or disc-type) alternators have the advantage of low cost and ease of manufacture. However, they are not generally considered for high power applications due to large eddy current losses and excessive heating at speeds above 1000 rpm. Axial gap alternators can be made with a relatively small radial dimension. For flywheel alternator applications, where the inertia of the flywheel is critical for engine operation, radial constraints are often secondary. Radial gap permanent magnet alternators can have either an interior or exterior rotor. Again, for applications where the inertia of the flywheel is necessary for engine operation, the exterior rotor is often preferred. This configuration places the largest amount of mass at the greatest radial distance from the crankshaft axis. The engine inertia can be increased (speed fluctuations reduced) for the same rotor mass. This configuration is preferred for mobile applications where weight is the primary design constraint.

Electrical power is generated by the motion of the permanent magnets (magnetic field) 233 passed the stator (stationary armature) 234. As the alternately oriented north and south magnetic pole pieces pass the stator coils 235, they induce a voltage in the coils 235 first in one direction and then in the opposite direction in accordance with the type of pole. The frequency and magnitude of the alternator output voltage is directly related to the speed of the alternator rotor 405. For flywheel alternators 211, where the alternator rotor 405 is mounted on the engine crankshaft 213, the output voltage is also directly related to the rotational speed of the crankshaft 213. Therefore, speed fluctuations minimized by the flywheel inertia also effect alternator performance. If the permanent magnets 233 pass the stator faster, the voltage will alternate directions more quickly, leading to a higher frequency. The magnitude of the voltage induced in the stator coils 235 is dictated by Faraday's Law, which states that the induced voltage is directly proportional to the rate of change of magnetic flux. This rate of change is again dictated by the speed with which the magnetic poles pass the coils 235. As this speed increases, so does the induced voltage.

The applied load dictates the current. However, the magnetic field from the load current creates a counter-torque to the mechanical torque applied to the shaft. Therefore, as the load current increases, the rotational speed of the shaft is slightly reduced, and this in turn decreases the frequency and level of the output voltage.

The permanent magnets 233 are preferably made from high power density materials such a samarium cobalt (SmCo) or neodymium-iron-boron (NdFeB), although any permanent magnet material can be used. The magnets 233 must be maintained at a temperature low enough to prevent demagnetization of the magnets. Sm₅Co is used in the currently preferred embodiment due to relatively high maximum working temperature and superior corrosion resistance properties when compared to other high power density permanent magnets. The magnet reversible temperature coefficient of magnetization of Sm₅Co in the currently preferred embodiment does not exceed −0.035% per ° C. over a range from 25° C. to 250° C.

For high power and high efficiency operation of the alternator the permanent magnets must be mounted in a magnetic material, such as AISI 1215 or AISI 1018 steel. The magnetic ring or alternator hub 406 must have a cross sectional area large enough to carry the magnetic flux of the alternator. That is, the magnetic flux density in the alternator hub 406 must not exceed the saturation flux density of the material at maximum operating conditions. The cross sectional area of the alternator hub 406 must also be great enough to handle the stress (hoop stress) created by rotation and must be large enough so that when combined with the other rotating component of the flywheel alternator 211 creates sufficient inertia so as to minimize speed fluctuations. In order to maximize power output, the permanent magnets 233 should be mounted to the alternator hub 406 with alternating pole directions and mounted in an alternator hub 406 manufactured from magnetic material. Other configurations with permanent magnets mounted in uniform pole directions and/or mounted in a rotor fabricated from a non-magnetic material are possible. These configurations are typically used to create a low voltage and/or low current signal typically used to create a spark for spark ignition type internal combustion engines or to power auxiliary equipment. These types of magnetos should not be confused with the disclosed invention wherein large quantities of power must be generated. The efficiency of the currently preferred embodiment is required so that excessive waste heat is not generated. If excessive amounts of waste heat are generated in power generation equipment, then the size and weight of the cooling system become large and lightweight portable units are not feasible. The permanent magnets 233 can be mounted to the alternator hub 406 through bonding, clipping, or any conventional method. In the currently preferred embodiment, electrically resistant epoxy 407 is used to adhere the permanent magnets to the magnetic ring. In order to minimize the rotor mass while maximizing the rotor inertia, the components with the densest material are placed at the greatest radial distance from the crankshaft axis of rotation 408. Components that are not at relatively large radial distances contribute very little to the flywheel inertia. Therefore, these components should be made as light as possible. Therefore, the flywheel spokes, fan hub 223′, and fan blades 221′ are fabricated from a different material than the alternator hub 406. In the currently preferred embodiment, these components are fabricated from a lightweight alloy such as aluminum. The cross-sectional area of the spokes must be sufficient to handle stresses created by the rotation of alternator, magnetic forces imposed by the alternator, and torque transmitted from the mounting portion of the flywheel to the inertia portion of the flywheel. In the currently preferred embodiment the flywheel contains a counterbore 409 to concentrically locate the alternator hub 406 with respect to the flywheel and to maintain a uniform radial airgap circumferentially about the alternator stator 234. Fasteners 306 or clips are used to retain the alternator hub 406 within the flywheel counterbore 409. Alternator hub drive members 411 and flywheel drive members 412 are formed to transmit torque without relying on the fasteners 306. The fasteners 306 merely act to prevent axial movement.

In the currently preferred embodiment, the alternator hub 406 has an inside diameter of 7.300 inches and outside diameter of 8.000 inches. The axial length of the alternator hub 406 is 0.910 inches and corresponds to the axial length of the permanent magnets. The remainder of the flywheel is fabricated from 6061-T651 aluminum alloy. A counter bore 409 is cut on the backside of the alternator flywheel to provide a 0.740 inch clearance between the permanent magnets 233 and the 0.150 inch thick fan hub (solid spoke) 223′. The mounting hub 223′ has an outside diameter of 2.420 inches and a width an 11.42-degree tapered through hole for mounting to the crankshaft 213. The overall dimensions of the alternator flywheel, including the cooling fan, are 9.000 inches in diameter and 2.530 inches in length. The final mass of the flywheel alternator is 6.8 lbs. The steel alternator hub 406 portion provides 36.4 percent of the total inertia. The twelve permanent magnets 233 provide 20.3 percent of the total inertia. The aluminum fan 214 portion provides the remaining 43.3 percent of the total inertia.

The stator 234 is comprised of laminated steel 236 bonded together to form pole pieces. Copper coils 235, through which electric current is induced, are wound around each pole piece. The entire stator subassembly 234 is vacuum pressure impregnated to minimize the potential for electrical shorts and improve corrosion resistance.

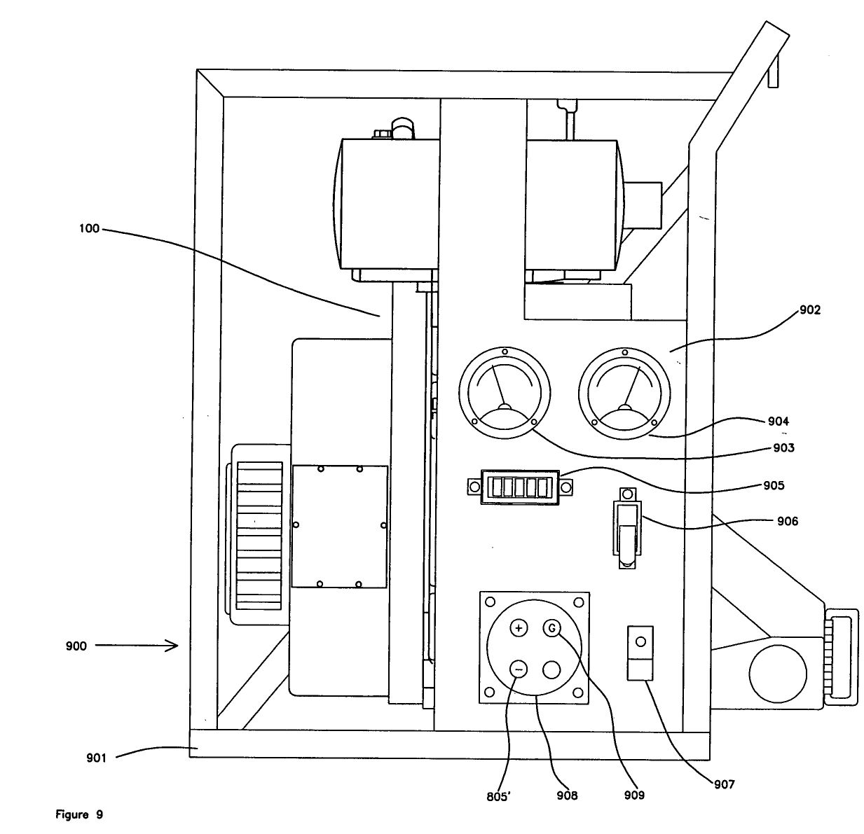

A schematic wiring diagram of the currently preferred embodiment of the stator and rectification electronics is shown in FIG. 8. In the currently preferred embodiment of the flywheel alternator, twelve alternating polarity Sm₅Co magnets generate the magnetic field. Two parallel circuits 801 each comprising a three-phase wye connected winding coil 802 are installed in seventy-two slots 803. Each circuit is comprised of thirty-six coils, twelve coils per phase, two turns per coil, and twenty-four turns per phase. The coil span is 1-5. Alternating current and voltage are produced with an amplitude and frequency proportional to the speed of the alternator. In the previously described configuration, with a rotational speed of 3600 rpm, the twelve-pole alternator produces a frequency of 360 Hz. This configuration was selected to improve ripple and output harmonics for rectified dc power generation. If it is desirable to use alternating current directly generated by the machine, then various combinations of speed and poles can be combined to produce 50 Hz, 60 Hz, 400 Hz or any frequency required by end-users.

In the currently preferred embodiment, rectifiers 224 are provided to convert alternating current into direct current. Diodes 804 in the rectifier produce waste heat that must be removed to maintain diode temperature below a prescribed temperature, typically 150° C. If heat is not removed, the diode life will be reduced significantly, ultimately ending in diode failure. Prepackaged rectifiers 224 can be employed to reduce assembly cost. The waste heat generated in a package rectifier 224 is typically removed from the rectifier base. For low power application, the base can be mounted to any heat sink, such as the generator frame, instrumentation panel, etc. Heat is removed by natural convection. For high power applications, the heat produced by the rectifiers is too large to be removed via natural convection, i.e. the diode temperature would exceed the prescribed temperature and the diodes would eventually fail. Forced air convection can remove larger quantities of heat required for high power applications.

In order to eliminate the size and weight of an external-cooling fan, the rectifiers can be mounted on the engine cowling of the engine. The engine fan circulates cool air across the rectifier base or a plate attached to the base prior to circulating the air to the engine. This configuration is desired because the rectifier must be maintained at a temperature less than the engine temperature (i.e., cylinder wall temperature). A single fan (integral to the flywheel as previously discussed) is used to cool the engine, the engine lubricating oil, the alternator, and the rectifiers or other electronics. The electronics box 226 can be removable and replaceable, which is advantageous for field servicing. The box 226 is attached to the engine cowling via a simple clamp connection such as a flange. Either the engine cowling 218 and electronics box 226 as a complete assembly or the engine cowling 218 and electronics box 226 as individual components may be isolated from engine vibration by the use of known vibration isolators. Therefore, electronic components (rectifiers, diodes, etc.) and electrical connections are not subjected to the same vibration as the engine. This minimizes the potential for electrical short-circuiting and maximizes protection against fasteners vibrating loose. The electronics box is typically enclosed with a sealed box cover plate 239 to protect the electrical components from the environment. An alternative method of fabricating the power electronics is to build up the system individual diodes 804 rather than using prepackaged rectifiers. Two diodes 804 are required for each generator phase.

In the currently preferred embodiment, three-phase power is produced in two parallel circuits 801. Therefore, two three-phase, full-bridge rectifiers 224 or twelve individual diodes 804 are used. Although other rectification approaches are possible, bridge-configured, three-phase full-wave rectification is the simplest, most cost effective, and lightest way of converting alternating current to direct current.

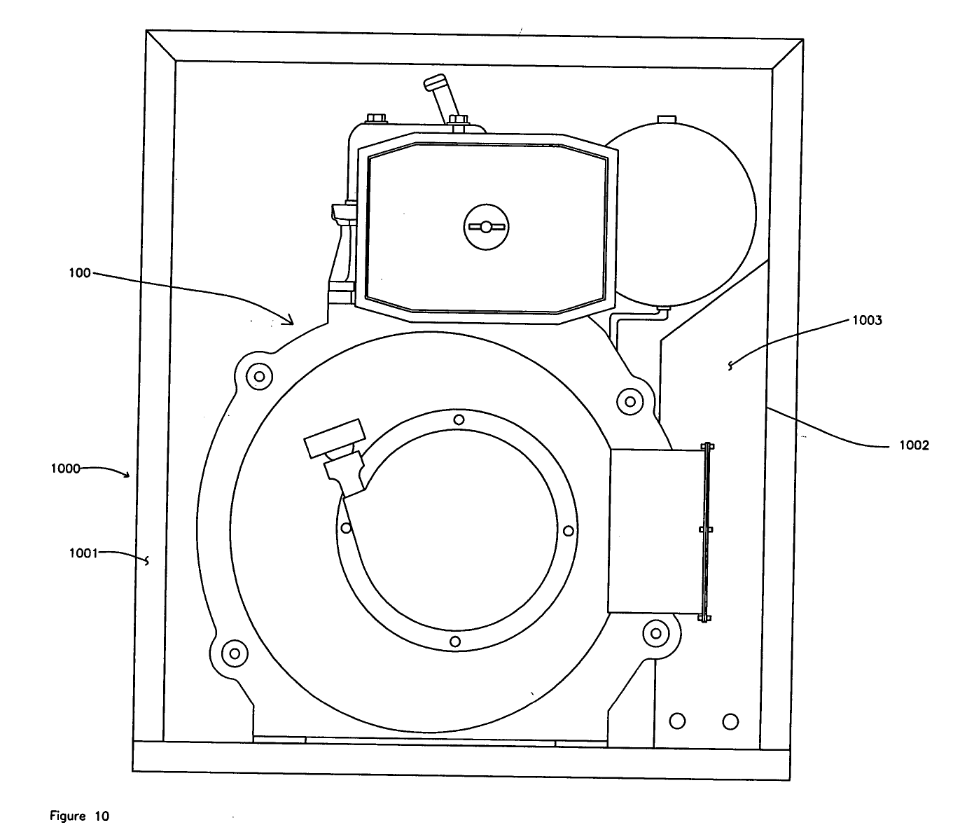

Generator sets as described herein can be produced as stand-alone units for applications requiring minimum weight. For instance a 2 kW, 28 VDC electric generator 100 has a dry weight of 48 lbs. Alternatively, the generator can be packaged in a frame. Two basic frame types are available; however, anyone skilled in the art will readily appreciate that other packaging configurations are possible. FIG. 9 shows a 2-kW, 28-VDC, backpack mounted generator 900 that has a dry weight of 65 lbs. Due to the tremendous weight savings of the invention, generators using compression ignition engines can be made small and light enough to be transported by a single person. Previously, in the 2-kW size range, this was not possible. The generator 100 can be hard mounted to the backpack frame 901 for extra rigidity during transport or it can be soft mounted to isolate engine vibration from the frame. An instrumentation panel 902, which can include gages such as a voltmeter 903, an ammeter 904, and an hour meter 905, is mounted on the frame. Circuit load protection 906 and a ground stud terminal 907 are typically included. A power receptacle 908 is provided that allows users to connect to the power terminals 805′ and instrument ground terminal 909. The power receptacle 908 can be of the circular connector type shown in the figure or any other terminal connector style. The output power of backpack generators of this type can be up to approximately 5 kW.

FIG. 10 shows one embodiment of a 2-kW, 28-VDC, rollcage mounted generator 1000 that has a dry weight of 63 lbs. In this case, the generator 100 is either hard or soft mounted into a rollcage frame 1001. Again, an instrument panel 1002 is typically included. A sealed instrument cover 1003 is typically included to protect the electronics from the environment. Both packaged configurations can optionally contain an on-board fuel tank or can have fuel fed from a line connecting an external fuel source. The output power of rollcage mounted generators of this type can be up to approximately 15 kW.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A portable power generator, comprising an engine composed of a light alloy material and having a flywheel, and an alternator operatively associated with the flywheel to form an integrated unit with the engine.

2. The generator of claim 1, wherein an engine cowling is provided to function as at least two of a fan shroud, a fan scroll, a distributor to cool the engine and the alternator, an electronic cold plate and one or more coolant ducts.

3. The generator of claim 1, wherein the distributor function of the engine cowling separates air flow to cool an engine head and cylinder wall of the engine as well as an oil sump.

4. The generator of claim 1, wherein the engine is an internal combustion engine.

5. The generator of claim 1, wherein the alternator is the sole component driven by the engine.

6. The generator of claim 1, wherein the engine includes an engine block and an engine block cover.

7. The generator of claim 1, wherein the light alloy material is a magnesium alloy.

8. The generator according to claim 6, wherein the engine further includes an engine head composed at least in part of a high temperature material.

9. The generator according to claim 1, wherein the alternator includes a cooling fan.

10. The generator according to claim 9, wherein the cooling fan is selected from the group consisting of a centrifugal fan, an axial fan and a mixed-flow fan.

11. The generator according to claim 10, wherein an engine cowling is provided to function as at least two of a fan shroud, a fan scroll, a distributor to cool the engine and the alternator, an electronic cold plate and one or more coolant ducts.

12. The generator according to claim 11, wherein the distributor function of the engine cowling separates air flow to cool an engine head and cylinder wall of the engine as well as an oil sump.

13. The generator according to claim 11, wherein a fan shroud for the cooling fan is operatively associated with the engine cooling to force air through the engine cowling.

14. The generator according to claim 9, wherein the cooling fan provides a mechanical link between an inertia component and a mounting portion of the flywheel.

15. The generator according to claim 14, wherein a lightweight alloy in the cooling fan constitutes the mechanical link and magnetic materials of the alternator's rotor provides the inertia component.

16. The generator according to claim 1, wherein the alternator is a permanent magnet alternator.

17. The generator according to claim 16, wherein the alternator and flywheel constitute a two-piece construction.

18. The generator according to claim 16, wherein the alternator is a radial gap, twelve-pole alternator.

19. The generator according to claim 18, wherein the alternator and flywheel constitute a two-piece construction.

20. The generator according to claim 1, wherein means is provided for converting alternating current produced by the alternator into direct current.

21. The generator according to claim 20, wherein the converting means comprises prepackaged rectifiers.

22. The generator according to claim 20, wherein an engine cowling is provided to function as at least two of a fan shroud, a fan scroll, a distributor to cool the engine and the alternator, an electronic cold plate and one or more coolant ducts.

23. The generator according to claim 22, wherein the distributor function of the engine cowling separates air flow to cool an engine head and cylinder wall of the engine as well as an oil sump.

24. The generator according to claim 23, wherein at least one coolant duct is associated with the oil sump which includes fins in the duct channel to enhance cooling.

25. The generator according to claim 22, wherein the converting means is arranged at the engine cowling.

26. The generator according to claim 20, wherein the alternator is configured to produce three-phase power in parallel circuits.

27. The generator according to claim 26, wherein the converting means comprise full-wave rectifiers.

28. The generator according to claim 27, wherein an engine cowling is provided to function as at least two of a fan shroud, a fan scroll, a distributor to cool the engine and the alternator, an electronic cold plate and one or more coolant ducts.

29. The generator according to claim 28, wherein the converting means is arranged at the engine cowling.

30. The generator according to claim 1, wherein a backpack mounting is provided for the engine and alternator.

31. The generator according to claim 30, wherein the engine and alternator are configured to produce a power output of up to about 5 kW.

32. The generator according to claim 1, wherein a rollcage mounting is provided for the engine and alternator.

33. The generator according to claim 32, wherein the engine and alternator are configured to produce a power output of up to about 15 kW.
